(19) United States
(12) Patent Application Publication
(10) Pub. No.: US 2020/0210875 A1
(43) Pub. Date: Jul. 2, 2020

(54) METHOD AND SYSTEM FOR PREDICTIVE ANALYTICS THROUGH THE USE OF FUZZY COGNITIVE MAPS IN A COMPUTING WITH WORDS ARCHITECTURE

(71) Applicant: Meraglim Holdings, Grand Cayman (KY)

(72) Inventors: John T. Rickard, Larkspur, CO (US); James Rickards, Portsmouth, NH (US); David G. Morgenthaler, Lakewood, CO (US)

(73) Assignee: Meraglim Holdings, Grand Cayman (KY)

(21) Appl. No.: 16/690,199

(22) Filed: Nov. 21, 2019

Related U.S. Application Data
(63) Continuation of application No. 16/690,120, filed on Nov. 21, 2019.
(60) Provisional application No. 62/785,823, filed on Dec. 28, 2018.

(51) Int. Cl. G06N 7/02; G06F 17/18; G06F 16/901

(52) U.S. Cl. CPC G06N 7/02; G06F 16/901; G06F 17/18

(57) ABSTRACT

The present invention is a computer-implemented method for calculating the relationship between concepts, comprising: generating, a map of a plurality of nodes; assigning, activation values for a set of exogenous nodes; establishing, a set of causal relationships between nodes; iterating, the map until a convergence state is reached by the set of non-exogenous nodes, wherein the convergence state represents a temporary equilibrium condition between the connected nodes; assigning linguistic terms to the node states and causal relationships based on a mapping between word index values and linguistic terms; and calculating the states of the set of non-exogenous nodes based on the linguistic terms associated with all of the connected nodes.

### CROSS-REFERENCE TO RELATED APPLICATIONS

This application is a continuation-in-part (and claims the benefit of priority under 35 USC 120) of U.S. application No. 62/785,823 filed Dec. 28, 2018. The disclosure of the prior applications is considered part of (and is incorporated by reference in) the disclosure of this application.

### BACKGROUND

This disclosure relates generally to the creation of fuzzy cognitive maps (FCMs) in a Computing With Words (CWW) architecture for the purpose of predictions, wherein all node states and link strengths in the FCM are represented using words drawn from specified vocabularies. The combination of these features is denoted as a FCM/CWW system, and refers more specifically to a method, computer program and computer system for generating the FCM from a corpus of written or verbal expert narratives from which concepts and linkages between concepts are extracted, instantiating the FCM elements with word-based states and word-based link strengths, designating the form of word-based aggregation functions for the positively and/or negatively causal inputs to each FCM node, iterating the FCM to a convergence point, and generating a forecast based on the converged iterations, which is generally represented in the form of pseudo-probability distributions over the output vocabulary words of particular nodes. The initial step of creating the cognitive maps may be performed manually by subject matter experts (SMEs) or with the aid of artificial intelligence (AI) methods including, e.g., natural language processing (NLP).

Cognitive mapping techniques as an analytical tool can be used in various information systems development and implementation activities. The three major cognitive mapping techniques include causal mapping, semantic mapping, and concept mapping. A causal map represents a set of causal relationships among constructs within a belief system. Semantic mapping, also known as idea mapping, is used to explore an idea without the constraints of a superimposed structure. Concept mapping is a graphical representation in which nodes represent concepts and links represent the positively or negatively causal relationships between concepts. Cognitive mapping techniques have been proposed to be applied in predictive analysis.

Of the cognitive mapping techniques, FCM/CWW systems are used iteratively to compute, for a given set of inputs to certain “exogenous” nodes, the converged activations of the remaining nodes that comprise the cognitive map in a manner that explicitly accounts for imprecision in one's knowledge of the node states and link strengths between various nodes in the architecture of the map. FCM/CWW techniques generalize and extend this approach by representing this imprecision in the form of words drawn from appropriate vocabularies. Artificial intelligence algorithmic techniques are used to perform the necessary calculations for the propagation of word-based representations of node states through the FCM/CWW architecture during the iterations leading to convergence, and also are used to calculate the probability distributions over the output word vocabularies of selected nodes.

Mathematically, FCM/CWW models are nonlinear dynamical systems represented by a collection of concepts, the pairwise link strengths describing the various positively or negatively causal relations that exist between pairs of concepts and the nonlinear aggregation functions used to determine the respective activation states of the concepts at each iteration. The concepts correspond to the FCM/CWW nodes and the causal relationships are represented by directed and signed links between pairs of nodes. Each FCM/CWW link is accompanied by a word that defines the (imprecise) strength of the causal relation between a pair of nodes. The sign of a link specifies whether the state of the source node has a positively or negatively causal impact on the state of its destination node. The composite inputs to each node are aggregated to determine the strength of activation of that node.

Certain of the FCM/CWW nodes in a given cognitive map are “exogenous” in the sense that that have no in-links from other nodes in the map, and thus their word states are determined from external information sources, which may include market data and/or news feeds, NLP, SMEs, outputs of other cognitive maps, or in general any source of external information. Given a set of exogenous node input states in the form of words, the FCM/CWW is iterated multiple times, holding the exogenous states fixed, until the remaining non-exogenous node states achieve converged word values, or more generally, a converged probability distribution over their respective word values. This probability distribution provides valuable predictive analysis of the corresponding output states of the non-exogenous nodes.

### SUMMARY

In a first embodiment, the present invention is a computer-implemented method for calculating the relationship between concepts, comprising: generating, by one or more processors, a map of a plurality of nodes; assigning, by one or more processors, activation values for a set of exogenous nodes; establishing, by one or more processors, a set of relationships between a set of non-exogenous nodes and the set of exogenous nodes; iterating, by one or more processors, the map until a convergence state is reached by the set of non-exogenous nodes, wherein the convergence state represents a temporary equilibrium relationship between the connected nodes; assigning, by one or more processors, a linguistic term to the relationship between the nodes based on a relationship between a word index value and a linguistic term; and calculating, by one or more processors, a state of each of the set of non-exogenous nodes based on the linguistic terms associated with all of the exogenous nodes.

In a second embodiment, the present invention is a computer program product for calculating the relationship between concepts, the computer program product comprising a computer readable storage medium having program instructions embodied therewith, the program instructions executable by a computing device to cause the computing device to: generate a map of a plurality of nodes; assign activation values for a set of exogenous nodes; establish a set of relationships between a set of non-exogenous nodes and the set of exogenous nodes; iterate the map until a convergence state is reached by the set of non-exogenous nodes, wherein the convergence state represents a temporary equilibrium relationship between the connected nodes; assign a linguistic term to the relationship between the nodes based on a relationship between a word index value and a linguistic term; and calculate a state of each of the set of non-exogenous nodes based on the linguistic terms associated with all of the exogenous nodes.

In a third embodiment, the present invention is a system comprising: a CPU, a computer readable memory and a computer readable storage medium associated with a computing device; program instructions to assign activation values for a set of exogenous nodes within a map; program instructions to establish a set of directional relationships between a set of non-exogenous nodes and the set of exogenous nodes; program instructions to iterate the map until the set of non-exogenous node relationships reach a convergence state; program instructions to assign a linguistic term to the convergence state of each of the set of non-exogenous nodes; and calculate a probability distribution across the vocabulary words for each of the non-exogenous nodes based on the linguistic terms associated with all of the exogenous nodes.

### BRIEF DESCRIPTION OF THE DRAWINGS

Referring now to the drawings in which like reference numbers represent corresponding parts throughout:

FIG. 1 depicts a representative computer system/server node implementation according to an embodiment of the present invention.

FIG. 2 depicts a cloud computing environment according to an embodiment of the present invention.

FIG. 3 depicts abstraction model layers according to an embodiment of the present invention.

FIG. 4 depicts a block diagram depicting a computing environment according to an embodiment of the present invention.

FIG. 6 depicts a diagram of a map, in accordance with an embodiment of the present invention.

FIGS. 7A-B depicts an illustration of a table depicting an iteration of each node within the map, in accordance with an embodiment of the present invention.

### DETAILED DESCRIPTION

The construction of solid forecasting models is desired to accurately and correctly detect future events (e.g. social, economic, political, and the like). This is beneficial to assist with calculating predictions and anticipating events. FCMs have been used to assist in implementing such models. However, past FCM approaches lack the interrelated features of the present invention.

In accordance with aspects of the present invention, a system and method for performing aggregations on non-exogenous nodes in a FCM based on the states of a set of exogenous and other non-exogenous nodes representing causal inputs to such nodes. The aggregation of the non-exogenous nodes is performed iteratively to a convergence point that establishes word descriptions of the converged states for predictions and forecasting relative to the identified FCM.

The invention represents a method and system for determining a state of at least one node within a FCM. For example, a FCM related to US and China relationships directed towards trade tariffs, and the FCM is populated with a plurality of nodes determined by SME to be related to this topic. The program is able to iterate the FCM to determine the state of specific nodes within the FCM. This iteration is not limited to just the node of interest, but the entire FCM due to the connections and associations of all nodes included in the FCM. In some embodiments, the visual representation of the FCM may be limited to the node(s) of interest, but the entire map is iterated to produce the output results. A change or adjustment to any one node, either by SME or a computing system, will have an effect on other node(s) within the FCM, The magnitude of the effect is determined by the calculation of the computing device described in this system. The node(s) of interest is typically a non-exogenous node. These nodes have states that are dependent upon the states of the exogenous nodes, as well as non-exogenous nodes to which they are causally connected. The present invention uses the CWW paradigm to represent the relationships between the nodes in linguistic terms instead of scalar values, since these relationships generally are imprecisely known. This is advantageous to provide for real world, real time, and relevant comparison of a multitude of information in a relatively short time, and have the ability to dynamically alter the data which is included in the iterations. CWW improves the interpretability of the FCM, and provides activation states of the nodes using words that provide a more realistic depiction than would be the case with more precise (e.g., scalar) values. Based on the nodes being generated using a variety of literary sources and using subject matter experts to extract the concepts and relationships, representing the state of the nodes using words whose meanings are well-understood by human users provides a meaningful and realistic identification of the node states.

In additional, alternative embodiments, relationships may be represented by a scalar value or by a defined function. This scalar value may be, in some of these embodiments, contained within an arbitrarily defined interval range, while the function may be defined over an arbitrary interval of its support. Calculating a prediction based on the collected data, a scalar value represents a precise indication of how a node (concept) is effected by, or what affect that node has, on other nodes in the FCM. In some embodiments, this scalar value can be mapped into a linguistic term. The aggregation functions used in the FCMs enable the modeling of a large range of behaviors, including those characteristic of critical threshold phenomena. For a set of activated exogenous nodes, non-exogenous nodes are iterated until convergence. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

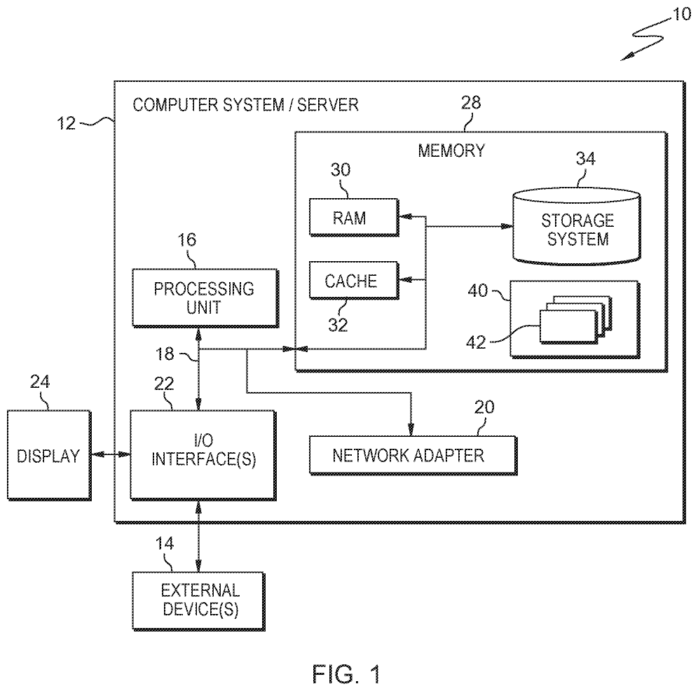

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

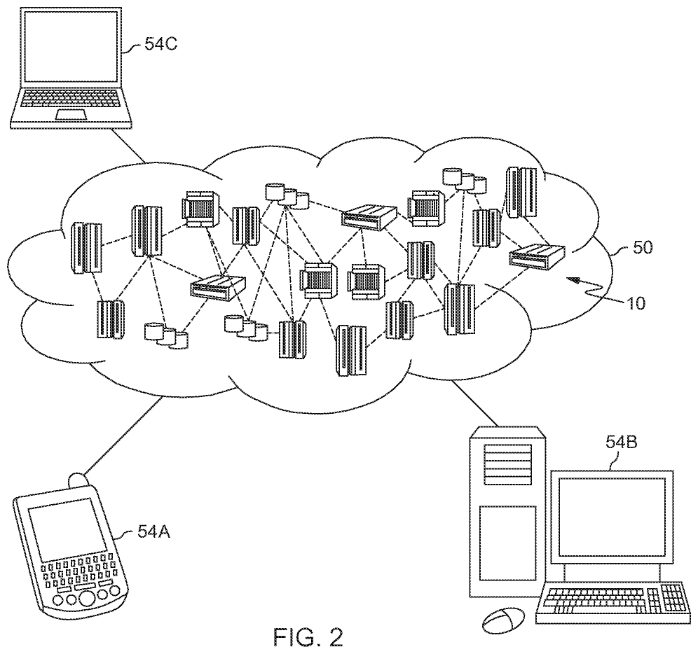

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that cloud computing nodes 10 and cloud computing environment 50 can communicate with any type of computerized device over any type of network and/or network addressable connection (e.g., using a web browser).

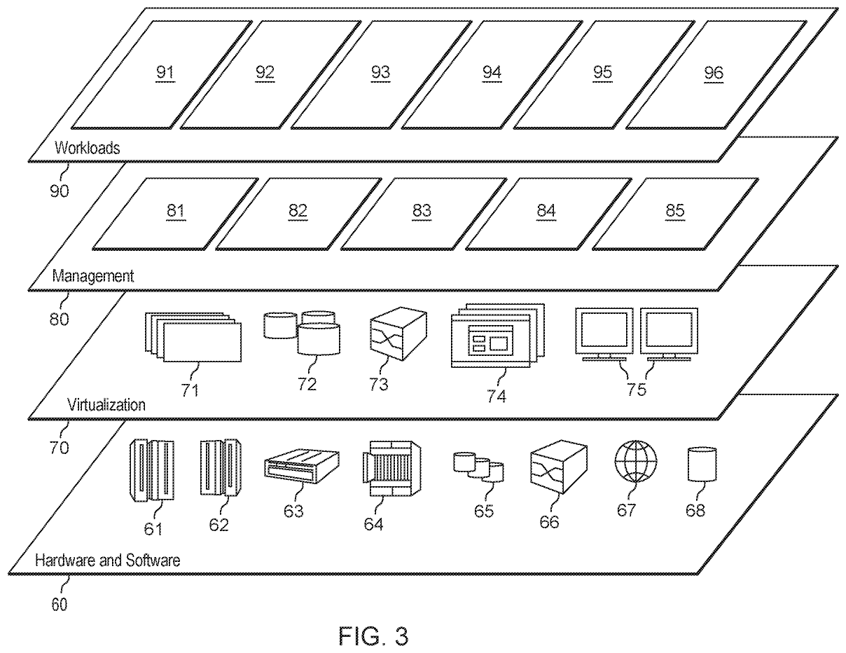

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and parking space selection 96.

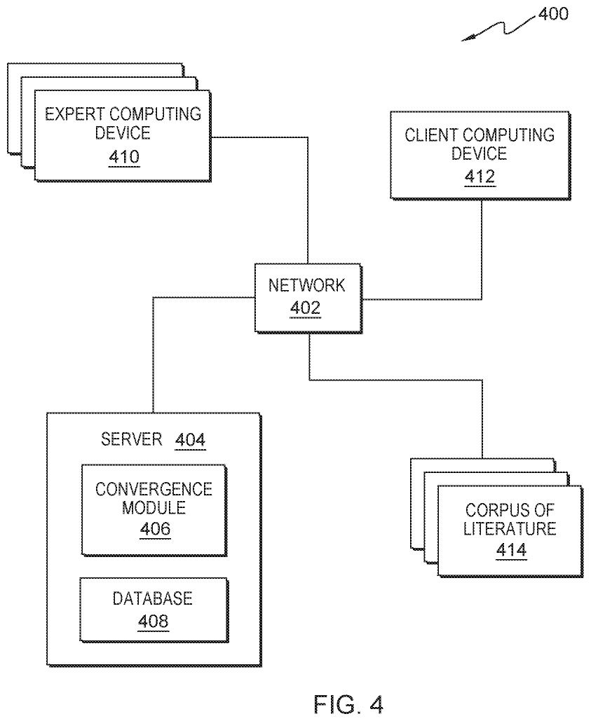

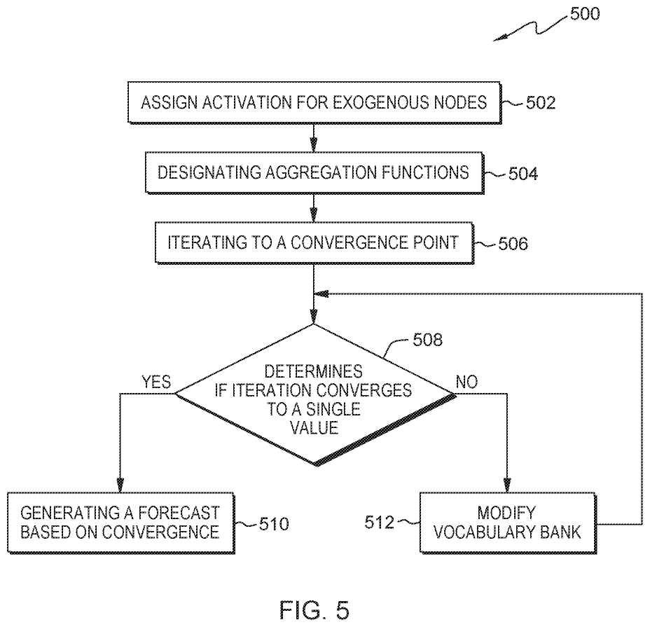

FIG. 4 depicts a block diagram of a computing environment 400 in accordance with one embodiment of the present invention. FIG. 1 provides an illustration of one embodiment and does not imply any limitations regarding the environment in which different embodiments maybe implemented.

FIG. 4 depicts a block diagram of a computing environment 400 in accordance with one embodiment of the present invention. FIG. 4 provides an illustration of one embodiment and does not imply any limitations regarding the environment in which different embodiments maybe implemented. In the depicted embodiment, computing environment 400 includes network 402, server 404, expert computing devices 410, client computing device 412, and corpus of literature 414. Computing environment 400 may include additional servers, computers, or other devices not shown.

Network 402 may be a local area network (LAN), a wide area network (WAN) such as the Internet, any combination thereof, or any combination of connections and protocols that can support communications between server 404, expert computing devices 410, client computing device 412, and corpus of expert narratives 414 in accordance with embodiments of the invention. Network 402 may include wired, wireless, or fiber optic connections. The network 402 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 402 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 402 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

Expert computing device(s) 410 comprise one or more computing devices which can receive input from an information source and transmit and receive data via network 402. The expert computing device 410 may be any other electronic device or computing system capable of processing program instructions and receiving and sending data. In one embodiment, the expert computing device 410 is a conventional computer system executing, for example, a Microsoft Windows compatible operating system (OS), Apple OS X, and/or a Linux distribution. In another embodiment, the expert computing device 410 can be a device having computer functionality, such as a smart-phone, a tablet, a personal digital assistant (PDA), a mobile telephone, etc. In some embodiments, expert computing device 410 may be a laptop computer, tablet computer, netbook computer, personal computer (PC), a desktop computer, or any programmable electronic device capable of communicating with server 404, client computing device 412, and corpus of expert narratives 414 via network 402. In other embodiments, the expert computing device 410 may represent a server computing system utilizing multiple computers as a server system, such as in a cloud computing environment. In another embodiment, the expert computing device 410 represents a computing system utilizing clustered computers and components to act as a single pool of seamless resources.

Client computing device(s) 412 comprise one or more computing devices which can receive input from a user and transmit and receive data via network 402. The client computing device 412 may be any other electronic device or computing system capable of processing program instructions and receiving and sending data. In one embodiment, the client computing device 412 is a conventional computer system executing, for example, a Microsoft Windows compatible operating system (OS), Apple OS X, and/or a Linux distribution. In another embodiment, the client computing device 412 can be a device having computer functionality, such as a smart-phone, a tablet, a personal digital assistant (PDA), a mobile telephone, etc. In some embodiments, client computing device 412 may be a laptop computer, tablet computer, netbook computer, personal computer (PC), a desktop computer, or any programmable electronic device capable of communicating with server 404, expert computing device 410, and corpus of literature 414 via network 402. In other embodiments, the client computing device 412 may represent a server computing system utilizing multiple computers as a server system, such as in a cloud computing environment. In another embodiment, the client computing device 412 represents a computing system utilizing clustered computers and components to act as a single pool of seamless resources.

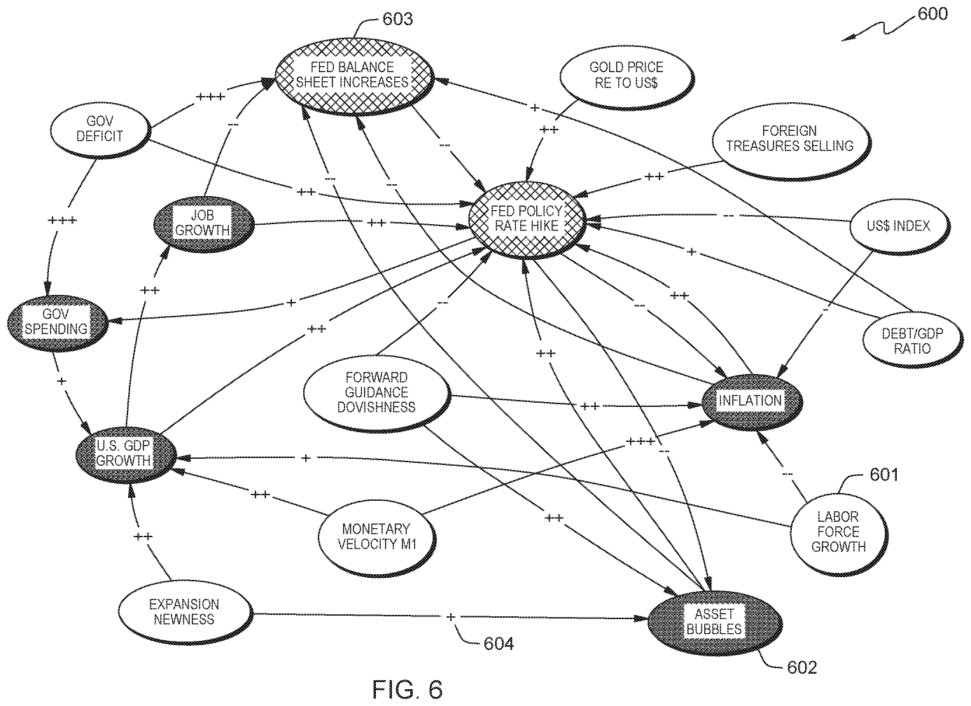

The client computing device 412 works with the convergence module 406 to retrieve the data and optimizes the data to enhance the user experience and provide a visualization that is both user friendly and aesthetically pleasing. The convergence module 406 may have visualization applications that convert the data to improve upon the visualization of the data and thereby improve the user experience. FIG. 6 depicts an example of a visualization of the data to improve the user experience. The presented data allows the user to execute a number of functions and commands to interact with the user interface. Based on the data which is presented to the client. The user interface may take on various forms and embodiments based on the client, the preferred aesthetics, and the desired level of interaction. The depicted embodiment is shown purely for exemplary purposes and is not intended to limit the computer-generated image of the FCM. A multitude of visual aspects and improvements may be incorporated into the visualization of the data to improve the user experience.

Corpus of expert narratives 414 includes one or more pieces of content that is related to a topic selected by the expert computing device 410, the client computing device 412, or the convergence module 406. The corpus of literature 414 comprise a corpus of literature which may include, but is not limited to, any textual, graphical, pictorial (images or videos), audio, or the like, which may contain information or data related to the selected topic. This can include articles, reports, web pages, presentations, interviews, audio recording, databases, or any piece of information work (or data) with the intention of relating information in a presentable form which is accessible by network 402. In some embodiments, hard copies of these sources may be located and used, and the information stored in database 408 through various means of transferred the material to virtual data.

Database 408 may be a repository that may be written to and/or read by expert computing device 410 or convergence module 406. Data collected by the expert computing device 410, topics selected by the client computing device 412, all or portions of the sources, as well as other data generated by the convergence module 406 may be stored in database 408. In one embodiment, database 408 is a database management system (DBMS) used to allow the definition, creation, querying, update, and administration of a database(s). In the depicted embodiment, database 408 resides within server 404. In other embodiments, database 408 resides on another server, or another computing device, provided that database 408 is accessible by convergence module 406 and expert computing devices 410 and their components.

Server 404 may be a management server, a web server, or any other electronic device or computing system capable of processing program instructions and receiving and sending data. In another embodiments server 404 may be a laptop computer, tablet computer, netbook computer, personal computer (PC), a desktop computer, or any programmable electronic device capable of communicating via network 402. In one embodiment, server 404 may be a server computing system utilizing multiple computers as a server system, such as in a cloud computing environment. In one embodiment, server 404 represents a computing system utilizing clustered computers and components to act as a single pool of seamless resources. In the depicted embodiment convergence module 406 and database 408 are located on server 404.

Convergence module 406 functions to instantiating the FCM/CWW elements with word-based states and word-based link strengths, designating the form of word-based aggregation functions for the inputs to each FCM/CWW node, iterating the FCM/CWW to a convergence point, and generating a forecast based on the converged iterations. The vocabularies may be determined by the convergence module 406, a third party, or a computer learning algorithm. The FCM/CWW systems are instrumented using computing with words technology that enables the use of words from appropriate vocabularies to describe the activation states of specific nodes and the positively or negatively causal relations between the nodes. The choice of aggregation functions used in the different nodes enables the modeling of a large range of behaviors, including those characteristic of critical threshold phenomena. For a set of exogenous concept activations, the FCM/CWWs are iterated until a convergence point is reached. The converged activations of the non-exogenous nodes are represented by normalized distributions of word similarities over their corresponding vocabularies, thus providing predictions of the states of these nodes for the given inputs. In the depicted embodiment, the convergence module 406 resides on server 404 and utilizes network 402 to access corpus of expert narratives 414. In other embodiments, the convergence module 406 may be located on another server, computing device, or exist in a cloud computing system, provided the convergence module 406 has access to corpus of expert narratives 414,d expert computing device 410, or an SME within the network 102.

FIG. 5 depicts a flowchart of the operational steps 500 taken by the convergence module 406 to iterate the FCM/CWW to a convergence point, in accordance with an embodiment of the present invention. FIG. 5 provides an illustration of one embodiment and does not imply any limitations regarding a computing environment in which different embodiments may be implemented. Many modifications to the depicted flowchart may be made.

The present method provides for the iteration of the FCM as a whole. Due to the connection and association of all nodes with the FCM, at each iteration each and every node is included to provide for the most accurate and up-to-date results as possible. While it may be possible to remove or hid various nodes at the request of the client or other third party, these actions may result in a less than perfect converged iteration state for each non-exogenous node. In some embodiments, a specific non-exogenous node or a plurality of non-exogenous nodes within a FCM may be selected and a predetermined degree of relationship of exogenous nodes may be selected. The method described below is in relation to the FCM of FIG. 6, however the process is designed to be applied to an FCM of hundreds or thousands of nodes. This method is designed to be applied to the FCM as whole. Additionally, the entire FCM is iterated simultaneously. However, in additional embodiments, the FCM may be iterated in stages or sections based on the computing device(s) limitations or the size of the FCM. This type if iteration may produce less accurate results by not incorporating the totality of the FCM. In the method below, a FCM has already been created.

In step 502, the convergence module 406 assigns the nodal activation state for each exogenous node within the FCM. For exogenous nodes, the activation state is fixed. The activation state for each exogenous node may be set manually through a SME, market data or other manual source, or the exogenous nodes may be set automatically by a natural language processing system or calculated based on the states of other nodes in other FCM. For the non-exogenous nodes, the initial activation state may be arbitrarily assigned and the converged state is calculated through the iteration process described below. The activation state of the exogenous nodes may be assigned by the convergence module 406, a third party, or an additional process or computer learning program. This activation state may be periodically adjusted based on the location or discovery of additional information or data which affects the node in question or from the activation or weight of a connected node from a separate or independent FCM. In some embodiments, a number of different FCMs exist and these FCMs may be connected to one another. The connection may be through the overlapping of nodes within two or more FCMs or the connection may be between a causal relationship between nodes of different FCMs. In either situation, the adjustment of the activation state of one external node may require an adjustment of the activation states of the exogenous nodes in other FCMs based on the overlapping of nodes or the causal relationship of the nodes.

For example, FIG. 6 shows FCM “FED POLICY” with exogenous node “EXPANSION NEWNESS”. This exogenous node may have a causal relationship with a node in another FCM or may overlap with another FCM. Therefore, if convergence module 406 adjusts the activation state for a node within one of these other FCMs (not shown), it may require the adjustment of the activation state of the “EXPANSION NEWNESS” node and potentially other nodes within the present FCM. In some embodiments, convergence module 406 determines if the adjustment of the activation state of a node requires the adjustment of other nodes based on the severity of the adjustment of the original node. For instance, if the adjustment of the activation state of a node would not have any affect on the iteration of the FCM. The convergence module 406 does not adjust the activation state of the unaffected nodes.

In some embodiments, a SME provides an adjustment to the fixed state of the exogenous nodes as new information is presented to the SME. In some embodiments, the convergence module 406 identifies new information and automatically adjusts the state of an exogenous node. The convergence module 406 provides various semantic searches and processes to collect, identify, process, and incorporate the newly identified information and calculate an adjustment to the fixed state of the exogenous node(s), thereby altering the state of the exogenous node with the calculated adjustment. This may be performed using NLP, market data algorithms or other similar processes known to one skilled in the art. This process of assigning the activation states of the exogenous nodes, may also include the process of modifying the connections and/or their strengths between an exogenous node and any related nodes in the FCM.

In a broader context, the nodal state is characterized by one or more linguistic identifier(s), each of which is associated with a word or phrase from a predetermined or selected vocabulary. The values may be associated based on similar context, topics, synonyms, antonyms, or other factors which are associated with the relationship (either positive or negative) between the topic of the node and the located data.

In various embodiments, the vocabulary may be related to one or more languages, e.g. English, French, Italian, Spanish, Chinese, Japanese, etc. Where the linguistic identifiers are in a foreign language, the convergence module 406, a third party computer program, or a person translates the necessary materials or linguistic identifiers to the desired language.

In step 504 the convergence module 406 designates the aggregation function(s) to process the FCM for the non-exogenous nodes. Through the use of various operators, the convergence module 406 is able to iterate the FCM to determine the activation state vectors that are described using words. The FCM determines the relationship between each connected node in terms of causal relationship. Each exogenous node either has a positive or negative causal relationship with each non-exogenous node. The convergence module 406 uses words or linguistic terms to build reasoning modules that have high interpretability. In one embodiment, the convergence module 406 uses interval type-2 fuzzy membership functions and a weighted power mean operator to iterate the non-exogenous nodes to a linguistic value. Various fuzzy membership functions may be implemented, such as, but not limited to, type-0 (scalar), type-1, type-2, and higher-order membership functions. In some embodiments, a squashing function is used to replace the weighted power mean type operator. In additional embodiments, a symbolic model is used to iterate the FCM for the non-exogenous nodes.

The convergence module 406 designates an aggregation function for both the positively and negatively causal inputs to be used for the iteration of the CM. The aggregation function is generally a non-linear aggregation function. However, any linear or non-linear aggregation function known to one of ordinary skill in the art or created by one of ordinary skill in the art, may be designated by the convergence module 406, based on the entirety of the FCM, the non-exogenous node(s) which are the focus, and previously aggregated FCMs. In most embodiments, there are separate aggregation functions selected for the positive causal and negative causal links, as appropriate. These functions may be selected dynamically as the FCM is adjusted and the exogenous nodes activation state changes.

In step 506 the convergence module 406 iterates the FCM to a convergence state. The convergence module 406 performs a desired number of iterations until the word output for each non-exogenous node reaches a stable state. The number of iterations may vary greatly depending on the FCM, the non-exogenous node(s), the exogenous node(s), and various other factors. Various threshold functions may be employed in this convergence iteration based on the desired tolerance to the observed value or the number of iterations, and any restrictions or limitations which are desired or required. Once this stable state is reached, the similarities of the non-exogenous node output membership functions to each of their corresponding vocabulary words is calculated using various artificial intelligence techniques, and the distribution of these similarities is normalized so that the values sum to unity, as appropriate for a probability distribution. These probability distributions provide valuable predictive analysis of the corresponding output states of the non-exogenous nodes. The convergence state represents an equilibrium for the FCM based on the present set of nodes and the value associated with the exogenous nodes. This convergence state generally represents only a temporary equilibrium state for the FCM, as new information and data is regularly being added into the FCM. The iteration of the FCM may occur at predetermined intervals, when new data or information is added to the FCM, when an exogenous node which is involved in the calculation is amended, or at the occurrence of other predetermined events or times.

In some embodiments, the iteration may not always converge to a stable state. In some embodiments, the iteration may produce a cyclic pattern, where the state activations cycle through repeating values after a certain number of iterations and continue in perpetuity. In some embodiments, the iterations may never converge or cycle and produce new values following each iteration. In either of these embodiments, the convergence module 406 may require external interference to assist in the convergence of the non-exogenous node states. In other embodiments, a warning or signal to identify the issue may be generated.

In step 510 the convergence module 406 generates a forecast based on the converged iteration of the non-exogenous node. The forecast is generally represented in the form of probability distributions over the output vocabulary word(s) of the non-exogenous node(s). The representation of the distribution is a prediction of an outcome or event based on related known or collected data. The representation of each topic by a distribution of numerical probability values over the featured set of nodes provides for evidence of the prediction. This data may be directly applied in the FCM to apply the numerical value to the non-exogenous node for a visual representation of the relationship between the selected nodes. In other embodiments, the forecast may be based upon any derivative of the information contained in the converged iteration of the non-exogenous node. Such information may include, for example, the mode or mean of the probability distribution, but is not restricted to any particular function of the distribution. It also may include any function of the raw output membership function of the non-exogenous node, prior to any mapping of this membership function into output vocabulary words. It will be apparent to one skilled in the art that any number of variations on the use of the information contained in the converged iteration of a non-exogenous node may be of interest.

FIG. 6 depicts a diagram of an FCM 600, in accordance with an embodiment of the present invention. The FCM 600 shows an example of what a particular FCM may look like, wherein there are both exogenous 601, non-exogenous nodes 602, and target non-exogenous nodes 603. The exogenous nodes 601 are identified in one color and the non-exogenous nodes 602 and 603 are identified in two colors. The connection 604 between the nodes is also shown indicating coarsely granular “positive” and “negative” association strengths between the nodes as well as a value identifying the affect the node has. The three strength levels in this figure are for illustration purposes only, as the association strengths will generally be expressed in other resolutions (i.e., using more or less than three strength levels). The color of the non-exogenous nodes 602 and 603 may be based on the client and the focus of that specific client. For example, the nodes shown may be the only nodes which are connected to the target nodes 603 through two degrees of separation. In the depicted embodiment, FED POLICY RATE HIKE and FED BALANCE SHEET INCREASES are the focus, hence the different color of these two non-exogenous nodes 603 when compared to the other non-exogenous nodes 602. This assists in improving the visualization of the FCM 600.

This image in FIG. 6 is an illustrative embodiment of the visual depiction of the FCM 600. The visuals of the map can be altered based on the client and the client's topic of interest. In its entirety the FCM 600 may be an extensive map of hundreds of nodes, all interconnected. For improving the visualization of the FCM 600 and providing the client with a readable and specific visual, the “unnecessary” portions of the map may easily be hidden based on the target non-exogenous nodes 603, the nodes which are directly (or indirectly to a predetermined degree of relationship) connected to the target non-exogenous node(s) 603. The hidden nodes may represent topics or matters which are not relevant or of interest to the client. However, these “unnecessary” nodes are still used in the calculation of the node states, but may not be necessary for the visual representation of the target nodes 603.

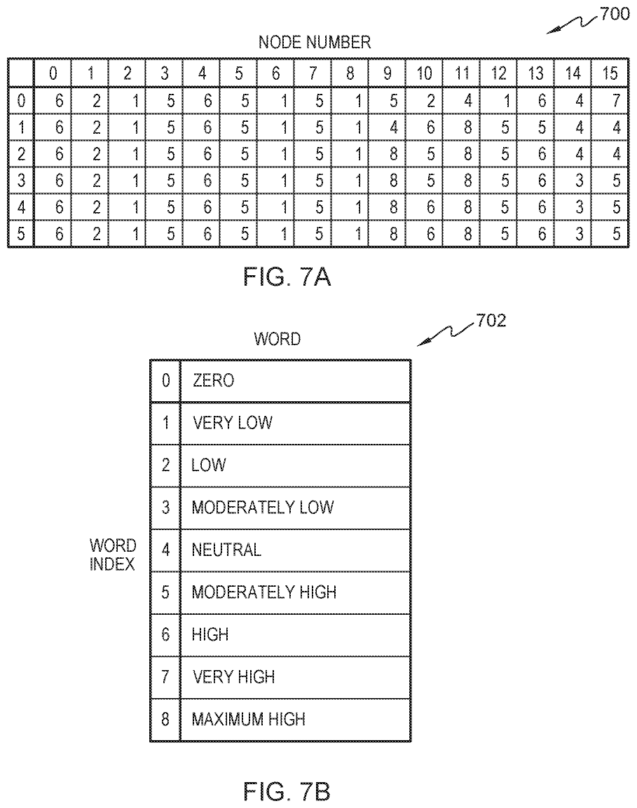

FIGS. 7A-B depicts a set of tables representing the state of each node for the FCM 600, in accordance with one embodiment of the present invention. Table 702 illustrates a sample vocabulary of linguistic terms. In the depicted table the words have a corresponding index number ranging from 0 to 8, and each index number has a word or linguistic term associated with it, ranging from zero to maximum high. The sample vocabulary may have a variety of different words or linguistic terms, which may be determined by SMEs, NLP, or other computing programs.

Table 700 depicts the word index value associated with each node (column) through each iteration (row) for a typical sequence of node states under the iteration. Note that through rows 0, 1, 2, 3, and 4 the word index values are changing. From the 4^{th} iteration to the 5^{th} iteration, the word index values reach a fixed or steady state, indicating the FCM has converged. In general, the number of iterations may vary and the number of nodes may vary. The convergence module 406 may iterate until either a fixed or steady point is discovered, until a cyclic condition is detected, or until some other stopping criterion is reached, e.g., a maximal number of iterations. The resulting probability distributions over the word index values (states) for each non-exogenous note are then represented in the FCM 600 as the current forecast for that node's corresponding concept label.

Table 702 depicts a set of nine index values to cover a representative range of positive or negative relationships between the two nodes. In additional embodiments, the number of index values and their corresponding vocabulary words may be increased or decreased based on the desired descriptive granularity of the vocabularies used.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A computer-implemented method for calculating the relationships between concepts, comprising:
generating, by one or more processors, a map of a plurality of nodes corresponding to the concepts;
assigning, by one or more processors, activation values for a set of exogenous nodes within the plurality of nodes;
establishing, by one or more processors, a set of causal relationships between the plurality of nodes;
iterating, by one or more processors, the map until a convergence state is reached for at least one non-exogenous node, wherein the convergence state represents an equilibrium condition between the connected nodes, given the states of the set of exogenous nodes;
assigning, by one or more processors, a linguistic term to the relationships between the nodes based on a relationship between word index values and their corresponding linguistic terms; and
calculating, by one or more processors, the states of the at least one non-exogenous node based on the linguistic terms associated with all of the connected nodes.

2. The computer-implemented method of claim 1, wherein the assigned activation values are developed by one or more subject matter experts in association with the set of exogenous nodes.

3. The computer-implemented method of claim 1, wherein a predetermined state is assigned to each exogenous node of the set of exogenous nodes involved in the iteration.

4. The computer-implemented method of claim 1, wherein the map is iterated a predetermined number of times.

5. The computer-implemented method of claim 1, wherein the map is iterated until a predetermined number of nodes have reached a convergence state.

6. The computer-implemented method of claim 4, wherein the number of iterations produces substantially identical results for successive iterations.

7. The computer-implemented method of claim 1, wherein a predetermined number of word index values are generated, and further comprising, assigning, by one or more processors, a linguistic term to each word index value.

8. The computer-implemented method of claim 7, wherein the membership function of each linguistic term spans a predetermined range of word index values.

9. The computer-implemented method of claim 1, wherein the activation values for the set of exogenous nodes, further comprising, adjusting, by one or more processors, the activation values based on the introduction of new information.

10. The computer-implemented method of claim 9, further comprising, determining, by one or more processors, if the adjustment of the activation value of at least one of the exogenous nodes would affect the iteration of the map, wherein if it is determined that the adjustment to the activation value of the at least one of the exogenous nodes would not affect the iteration of the map, negating, by one or more processors, the adjustment to the activation values of the set of nodes within the map.

11. The computer-implemented method of claim 1, further comprising, calculating, by one or more processors, a probability distribution across the vocabulary words for each of the non-exogenous nodes based on the linguistic terms associated with all of the exogenous nodes

12. A computer program product for calculating the relationship between concepts,
the computer program product comprising a computer readable storage medium having program instructions embodied therewith, the program instructions executable by a computing device to cause the computing device to:
generate a map of a plurality of nodes, wherein the plurality of nodes comprises at least one non-exogenous node and a set of exogenous nodes;
assign activation values for the set of exogenous nodes;
establish a set of causal relationships between the plurality of nodes;
iterate the map until a convergence state is reached for the at least one non-exogenous node, wherein the convergence state represents an equilibrium condition between the nodes for the given causal relationships, wherein the equilibrium condition is dependent upon the assigned activation values for the set of exogenous nodes;
assign a linguistic term to the relationship between the nodes based on a relationship between word index values and their corresponding linguistic terms; and
calculate the states of the at least one non-exogenous node based on the linguistic terms associated with the connected nodes.

13. The computer program of claim 12, wherein the assigned activation values are developed by one or more subject matter experts in association with the set of exogenous nodes.

14. The computer program of claim 12, wherein a predetermined membership function and operator are selected for the iteration.

15. The computer program of claim 12, wherein the map is iterated a predetermined number of times.

16. The computer program of claim 12, wherein the map is iterated until a predetermined number of nodes have reached a convergence state.

17. The computer program of claim 15, wherein the number of iterations produces substantially identical results for successive iterations.

18. A system comprising:
a CPU, a computer readable memory and a computer readable storage medium associated with a computing device;
program instructions to assign activation values for a set of exogenous nodes within a map;
program instructions to establish a set of causal relationships between and among at least one non-exogenous node with the set of exogenous nodes;
program instructions to iterate the map until the at least one non-exogenous node state reaches a convergence condition;
program instructions to assign a linguistic term to the convergence states of the set of non-exogenous nodes; and
calculate the convergence state of at least one non-exogenous node based on the linguistic terms associated with all of the connected nodes.

19. The system of claim 18, wherein convergence states may be represented by type-0 (scalar), type-1, type-2 or higher order (type-n) fuzzy membership functions.

20. The system of claim 18, wherein the iteration is performed until a predetermined number of substantially identical convergence states are calculated.
